(19) United States
(12) Patent Application Publication
(10) Pub. No.: US 2008/0257045 A1
(43) Pub. Date: Oct. 23, 2008

(54) Sensor device for detecting physical quantity

(75) Inventor: Masaki Takashima, Chiryu-city (JP)

Correspondence Address: POSZ LAW GROUP, PLC, 12040 SOUTH LAKES DRIVE, SUITE 101, RESTON, VA, 20191, US

(73) Assignee: DENSO CORPORATION, Kariya-city (JP)

(21) Appl. No.: 12/081,049

(22) Filed: Apr. 10, 2008

(30) Foreign Application Priority Data
Apr. 18, 2007 (JP) 2007-109389
Feb. 13, 2008 (JP) 2008-031818

(51) Int. Cl. G01P 15/125

(52) U.S. Cl. 73/514.32

(57) ABSTRACT

A sensor device includes a sensor chip, a circuit chip, a casing, a first adhesive member disposed between the sensor chip and the circuit chip, and a second adhesive member disposed between the circuit chip and the casing. The first adhesive member has an area smaller than that of the sensor chip and a distance between the first adhesive member and an outer peripheral edge of the sensor chip becomes a minimum at a portion adjacent to a centerline of the sensor chip. The second adhesive member has an area smaller than that of the circuit chip and a distance between the second adhesive member and an outer peripheral edge of the circuit chip becomes a minimum at a portion adjacent to a centerline of the circuit chip.

### CROSS REFERENCE TO RELATED APPLICATIONS

This application is based on Japanese Patent Applications No. 2007-109389 filed on Apr. 18, 2007 and No. 2008-031818 filed on Feb. 13, 2008, the contents of which are incorporated herein by reference in their entirety.

### BACKGROUND OF THE INVENTION

1. Field of the Invention

The present invention relates to a sensor device for detecting a physical quantity.

2. Description of the Related Art

Conventionally, a micro electro mechanical systems sensor chip (MEMS sensor chip) has opposing pectinate elements. When acceleration or angular velocity is applied to the MEMS sensor chip, a distance between the opposing pectinate elements changes. Thus, the MEMS sensor chip functions as a sensor by detecting a change of capacitance between the opposing pectinate elements. The change of capacitance due to the acceleration or the angular velocity is small. Thus, the MEMS sensor chip includes an amplifier circuit.

When an external stress is applied to the MEMS sensor chip, the MEMS sensor chip may be bent. Thereby, the capacitance may change and a property of the MEMS sensor chip may fluctuate. Thus, it is required to design the MEMS sensor chip so that the MEMS sensor chip is less affected by the external stress.

U.S. Pat. No. 7,249,509 (corresponding to JP-2006-23190A), U.S. Pat. No. 7,166,911 and US 2004/0041254A (corresponding to JP-2006-518673A) respectively disclose a sensor device including a MEMS sensor chip disposed in a package. In the sensor devices, an area of an element at which the MEMS sensor chip is attached or an area of a portion at which an adhesive agent for attaching the MEMS sensor chip is applied is smaller than an area of a surface of the MEMS sensor chip. In the present cases, a stress applied to the MEMS sensor chip is reduced compared with a case where the whole surface of the MEMS sensor chip is attached and fixed. When the attached area of the MEMS sensor chip is small, the MEMS sensor chip is less affected by the external stress. However, when the attached area is small, an adhesion force is reduced. Thus, the adhesion force may be insufficient, and a wire-bonding process for picking up a signal from the MEMS sensor chip may be difficult.

### SUMMARY OF THE INVENTION

In view of the foregoing problems, it is an object of the present invention to provide a sensor device for detecting a physical quantity.

According to an aspect of the invention, a sensor device includes a sensor chip, a circuit chip, a casing, a first adhesive member, and a second adhesive member. The sensor chip is configured to detect a physical quantity applied thereto. The circuit chip is electrically coupled with the sensor chip and is configured to process a signal from the sensor chip. The casing houses the sensor chip and the circuit chip. The first adhesive member is disposed between the sensor chip and the circuit chip. The first adhesive member has an area smaller than an area of the sensor chip and has a shape determined in such a manner that a distance between the first adhesive member and an outer peripheral edge of the sensor chip becomes a minimum at a portion adjacent to a centerline of the sensor chip. The second adhesive member is disposed between the circuit chip and the casing. The second adhesive member has an area smaller than an area of the circuit chip and has a shape determined in such a manner that a distance between the second adhesive member and an outer peripheral edge of the circuit chip becomes a minimum at a portion adjacent to a centerline of the circuit chip.

In the present sensor device, a property fluctuation can be reduced while ensuring sufficient adhesion forces between the sensor chip and circuit chip and between the circuit chip and the casing.

According to another aspect of the invention, a sensor device includes a sensor chip, a circuit chip, a casing, a first adhesive member, and a second adhesive member. The sensor chip is configured to detect a physical quantity applied thereto. The sensor chip has an approximately quadrilateral shape and has a plurality of bonding pad arranged along at least one side of the approximately quadrilateral shape. The circuit chip has an approximately quadrilateral shape and has a plurality of bonding pads arranged along at least one side of the approximately quadrilateral shape. A part of the bonding pads is electrically coupled with the plurality of the bonding pads of the sensor chip. The casing houses the sensor chip and the circuit chip and has a plurality of bonding pads electrically coupled with the other part of the bonding pads of the circuit chip. The first adhesive member is disposed between the sensor chip and the circuit chip. The first adhesive member has an area smaller than an area of the sensor chip and has an end portion located outside of the plurality of bonding pads of the sensor chip. The second adhesive member that is disposed between the circuit chip and the casing. The second adhesive member has an area smaller than an area of the circuit chip and that has an end portion located outside of the plurality of bonding pads of the circuit chip.

In the present sensor device, a property fluctuation can be reduced while ensuring sufficient adhesion forces between the sensor chip and circuit chip and between the circuit chip and the casing.

### BRIEF DESCRIPTION OF THE DRAWINGS

Additional objects and advantages of the present invention will be more readily apparent from the following detailed description of preferred embodiments when taken together with the accompanying drawings. In the drawings:

FIG. 1 is an exploded perspective view showing an angular velocity sensor according to a first embodiment of the invention;

FIG. 2 is a perspective view showing the angular velocity sensor in which a part of a lid is cutout;

FIG. 3 is a plan view showing a sensor chip in the angular velocity sensor;

FIG. 4A is a graph showing a relationship between an attached area ratio and a property fluctuation due to an external stress, and FIG. 4B is a graph showing a relationship between the attached area ratio and an adhesion force;

FIG. 5 is a graph showing a relationship between the attached area ratios of adhesive films and the property fluctuation due to the external stress;

FIG. 6A is a plane view showing an angular velocity sensor according to a comparative example, and FIG. 6B is a cross-sectional view showing the angular velocity sensor at a wire-bonding process;

FIG. 7A is a plane view showing the angular velocity sensor according to the first embodiment, and FIG. 7B is a cross-sectional view showing the angular velocity sensor at a wire-bonding process;

FIG. 8A is a plane view showing an angular velocity according to a modification of the first embodiment, and FIG. 8B is a cross-sectional view showing the angular velocity sensor at a wire-bonding process;

FIG. 9 is a plan view showing the angular velocity sensor according to the first embodiment;

FIG. 10 is an exploded perspective view showing an angular velocity sensor according to a second embodiment of the invention; and

FIG. 11 is a plan view showing an adhesive film according to other embodiment of the invention.

### DETAILED DESCRIPTION OF THE PREFERRED EMBODIMENTS

### First Embodiment

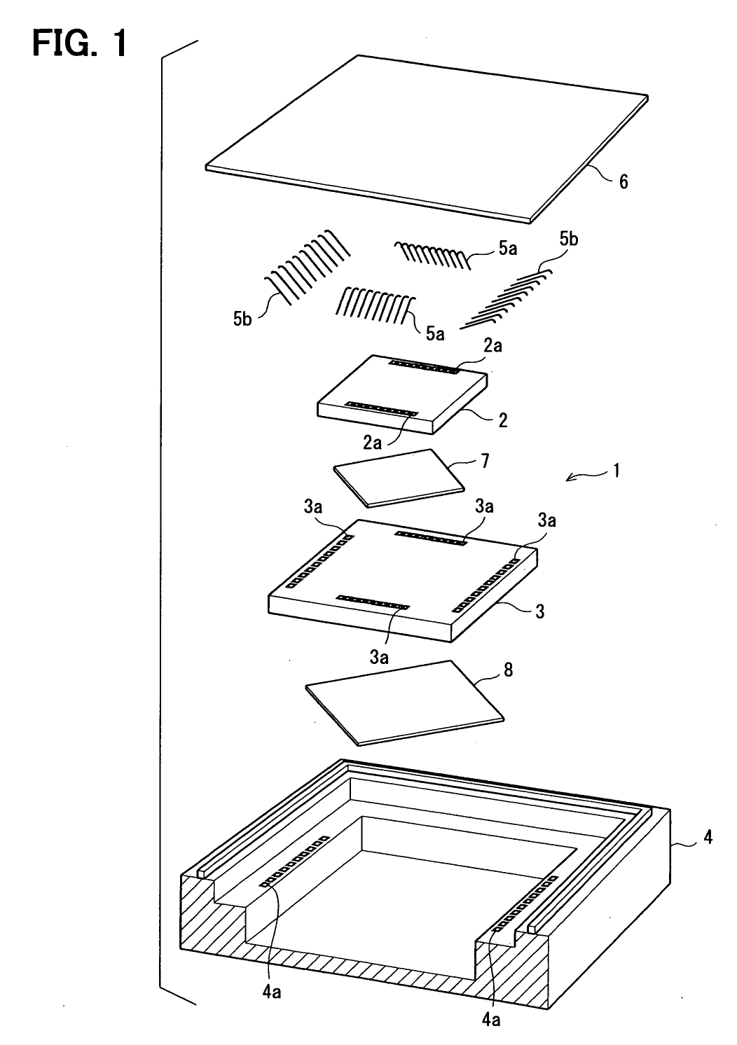

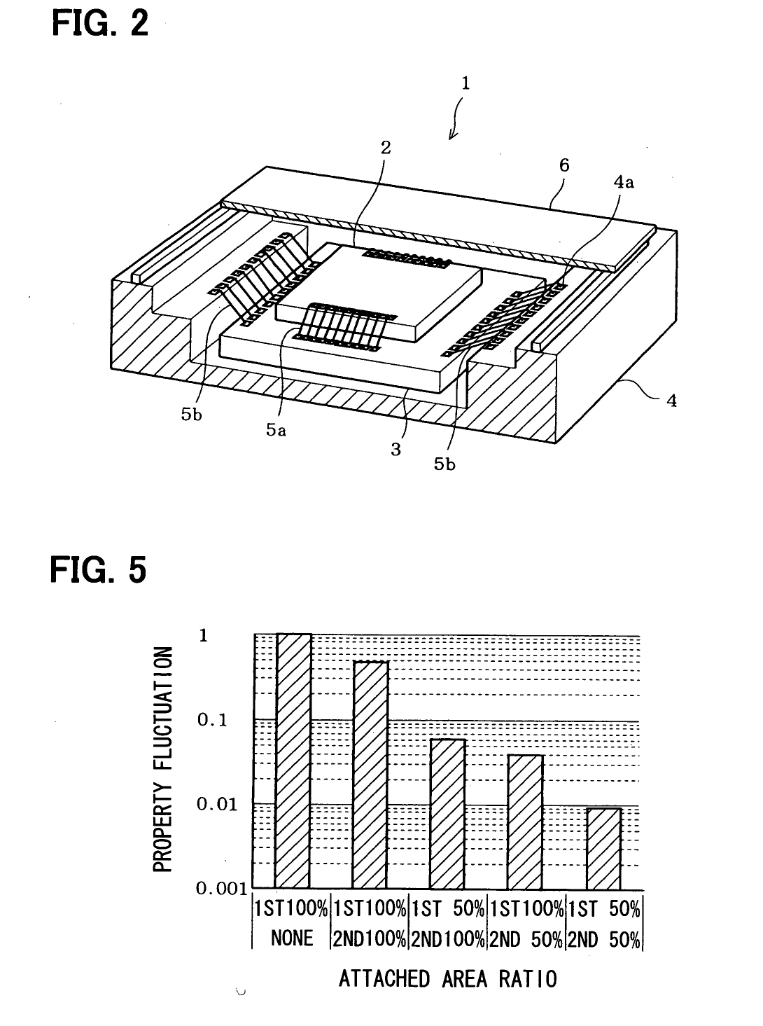

A sensor device according to a first embodiment of the invention will be described with reference to FIGS. 1-9. The sensor device according to the first embodiment can be suitably used for an angular velocity sensor 1 for controlling a vehicle, for example. As shown in FIGS. 1 and 2, the angular velocity sensor 1 includes a sensor chip 2, a circuit chip 3, and a casing 4. The circuit chip 3 is disposed under the sensor chip 2. The casing 4 is made of ceramic, for example, and houses the sensor chip 2 and the circuit chip 3 therein.

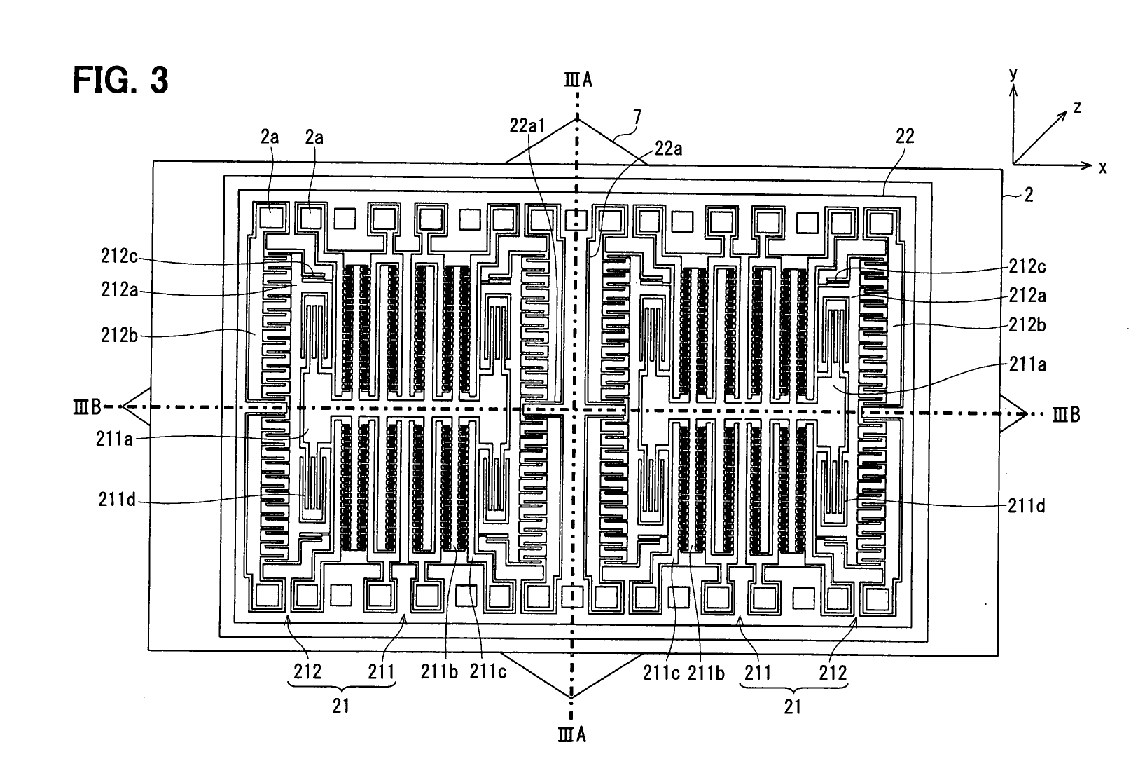

The sensor chip 2 has an approximately quadrilateral shape and an area about 20 mm², for example. As shown in FIG. 3, the sensor chip 2 has a pair of sensor elements 21 and a peripheral portion 22. The peripheral portion 22 has an approximately rectangular frame shape and is fixed to a ground electric potential. The pair of sensor elements 21 is held by the peripheral portion 22 and is arranged symmetrically with respect to the line IIIA-IIIA in FIG. 3.

Each of the sensor elements 21 has a driving portion 211 and a detecting portion 212. The driving portion 211 includes spindles 211a, driving movable-electrodes 211b, and driving fixed-electrodes 211c. The spindles 211a are held by the peripheral portion 22 to be movable. The driving movable-electrodes 211b have pectinate shapes and are integrally coupled with the spindles 211a. The driving fixed-electrodes 211c have pectinate shapes and are disposed approximately parallel to the driving movable-electrodes 211b. The driving fixed-electrodes 211c are driven at a predetermined frequency. The driving movable-electrodes 211b and the driving fixed-electrodes 211c are opposed to each other and have a predetermined distance therebetween. The spindles 211a, the driving movable-electrodes 211b, and the driving fixed-electrodes 211c are arranged symmetrically with respect to the line IIIB-IIIB in FIG. 3.

The detecting portion 212 includes detecting movable-electrodes 212a and detecting fixed-electrodes 212b. The detecting movable electrodes 212a are held by the peripheral portion 22 to be movable. The detecting fixed-electrodes 212b are arranged approximately parallel to the detecting movable-electrodes 212a. The detecting movable-electrodes 212a and the detecting fixed-electrodes 212b are opposed to each other and have a predetermined distance therebetween. The detecting fixed-electrodes 212b detect an angular velocity applied to the sensor chip 2 as a Coriolis force. The detecting movable-electrodes 212a and the detecting fixed-electrodes 212b are arranged symmetrically with respect to the line IIIB-IIIB in FIG. 3.

The driving movable-electrodes 211b are movable in an X-axis direction, and the detecting movable-electrodes 212a are movable in a Y-axis direction shown in FIG. 3. The Y-axis direction is approximately perpendicular to the X-axis direction and a Z-axis direction.

Specifically, detecting beams 212c are integrally coupled with the peripheral portion 22, and the detecting movable-electrodes 212a are integrally coupled with the detecting beams 212c. In addition, driving beams 211d are integrally coupled with the detecting movable-electrodes 212a, and the spindles 211a are integrally coupled with the driving beams 211d.

The peripheral portion 22 includes a stiffening member 22a that is located between the sensor elements 21. The stiffening member 22a has a cross shape and a center point of the cross shape is located at a center point of the sensor chip 2. The stiffening member 22a has X-axial parts 22a1 that extend in the X-axis direction. The X-axial parts 22a1 are located between center portions of the detecting fixed-electrodes 212b. The peripheral portion 22 and each of the electrodes have bonding pads 2a.

An operation of the sensor chip 2 for detecting the angular velocity will now be described. At first, a voltage signal that varies periodically is applied between the driving fixed-electrodes 211c and the driving movable-electrodes 211b, and thereby the spindles 211a vibrate in the X-axis direction. When the sensor chip 2 receives an angular velocity that has a rotation axis in the Z-axis direction, the Coliolis force acts on the spindles 211a vibrating in the X-axis direction, and thereby the spindles 211a displace in the Y-axis direction. Thus, the detecting beams 212c bend in the Y-axis direction, and the spindles 211a, the driving movable-electrodes 211b, and the detecting movable-electrodes 212a displace in the Y-axis direction.

The displacements of the spindles 211a in the Y-axis direction are transmitted to the detecting movable-electrodes 212a. A predetermined voltage is applied to the detecting movable-electrodes 212a and the detecting fixed-electrodes 212b. Thus, capacitances between the detecting movable-electrodes 212a and the detecting fixed-electrodes 212b change in accordance with the displacements of the detecting movable-electrodes 212a. The capacitances are detected by a capacitance-voltage (CV) converter circuit disposed in the circuit chip 3. Thereby, the angular velocity applied to the sensor chip 2 can be detected.

Each of the detecting fixed-electrodes 212b and each of the detecting movable-electrodes 212a are arranged approximately parallel to at least one side in a planar direction of the sensor chip 2. Thus, the change of the capacitances between the detecting fixed-electrodes 212b and the detecting movable-electrodes 212a are generated when the detecting movable-electrodes 212a move in a direction approximately parallel to at least one side in the planar direction of the sensor chip 2.

The spindles 211a of the pair of sensor elements 21 move to an opposite side in the X-axis direction for reducing an affect of a vibration noise from an outside of the sensor chip 2. When one of the sensor elements 21 displaces to a plus side in the X-axis direction, the other sensor element 21 displaces to a minus side in the X-axis direction. In the present case, when the angular velocity is applied to the sensor chip 2, the one sensor element 21 displaces to a plus side in the Y-axis direction, and the other sensor element 21 displaces to a minus side in the Y-axis direction.

The circuit chip 3 is configured to process a signal from the sensor chip 2. As shown in FIGS. 1 and 2, the circuit chip 3 has bonding pads 3a, and the bonding pads 3a of the circuit chip 3 and the bonding pads 2a of the sensor chip 2 are electrically coupled through bonding wires 5a, respectively. The sensor chip 2 and the circuit chip 3 are disposed in the casing 4. The lid 6 is disposed on the casing 4 to seal the casing 4. The casing 4 has terminal portions 4a for outputting a signal from the circuit chip 3 to an outside of the angular velocity sensor 1. The terminal portions 4a and the bonding pads 3a of the circuit chip 3 are coupled through bonding wires 5b, respectively.

As shown in FIG. 1, the sensor chip 2 and the circuit chip 3 are attached through a first adhesive film 7, and the circuit chip 3 and the casing 4 are attached through a second adhesive film 8. The casing 4 has an electrode on a lower surface thereof, and the electrode is soldered with a printed circuit board (not shown). Then, the casing 4 is covered with another casing (not shown).

When the printed circuit board having the angular velocity sensor 1 is bent for some reason, an external stress is applied to the casing 4. The external stress is transmitted from the casing 4 to the sensor chip 2 through the circuit chip 3. Thus, it is required that the stress applied to the sensor chip 2 is reduced. The stress transmitted between two members increases when an attached area of the two members is large. Thus, the transmittance of the stress can be restricted by the first adhesive film 7 and the second adhesive film 8. When attached areas of the first adhesive film 7 and the second adhesive film 8 are too small, adhesion forces between the members are reduced. Thus, it is required that the attached areas are reduced while ensuring sufficient adhesion forces.

Based on the above-described standpoint, a relationship between the areas of the adhesive films 7 and 8 and a property fluctuation due to the external stress and a relationship between the areas of the adhesive films 7 and 8 and the adhesion forces are measured by the inventor.

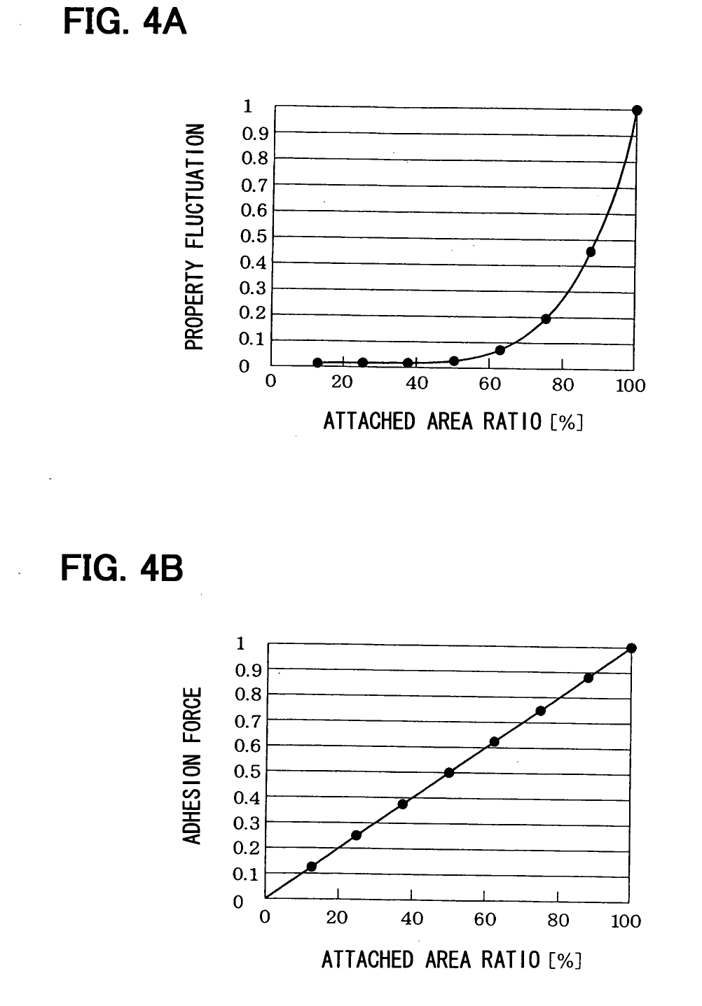

The experimental result is shown in FIGS. 4A and 4B. The areas of the adhesive films 7 and 8 are reduced with respect to bottom areas of the sensor chip 2 and the circuit chip 3, respectively. In a case where the areas of the adhesive films 7 and 8 are same as the bottom areas of the sensor chip 2 and the circuit chip 3, respectively, an attached area ratio becomes 100%. The property fluctuation and the adhesion force are shown as ratio with respect to the case where the attached area ratio is 100%. When the attached area decreases, the property fluctuation due to the external stress decreases in an exponential manner, as shown in FIG. 4A. In addition, when the attached area decreases, the adhesion force decreases in a linear manner, as shown in FIG. 4B. Based on the experimental result, an attached area ratio at which the property fluctuation is reduced to a target value and a sufficient adhesion force is ensured can be obtained. When the attached area ratio is about 70%, the adhesion force is about 70% and the property fluctuation is about 15% with respect to the case where the attached area ratio is 100%.

Next, the areas of the first adhesive film 7 and the second adhesive film 8 are changed respectively. As shown in FIG. 5, when both of the first adhesive film 7 (1ST) and the second adhesive film 8 (2ND) have areas of about 50% of the bottom areas of the sensor chip 2 and the circuit chip 3, respectively, the property fluctuation due to the external stress is effectively reduced compared with a case where one of the first adhesive film 7 and the second adhesive film 8 has the area of about 50% and the other one of the first adhesive film 7 and the second adhesive film 8 has the area of about 100%. Even when both of the first adhesive film 7 and the second adhesive film 8 have areas of about 100%, the property fluctuation is reduced compared with a case where the second adhesive film 8 is not provided.

Thus, in the angular velocity sensor 1, shapes of the first adhesive film 7 and the second adhesive film 8 are determined to satisfy two requirements including that the areas are small with respect to the bottom areas of the sensor chip 2 and the circuit chip 3, respectively, and that distances from each side of the sensor chip 2 and the circuit chip 3 are short.

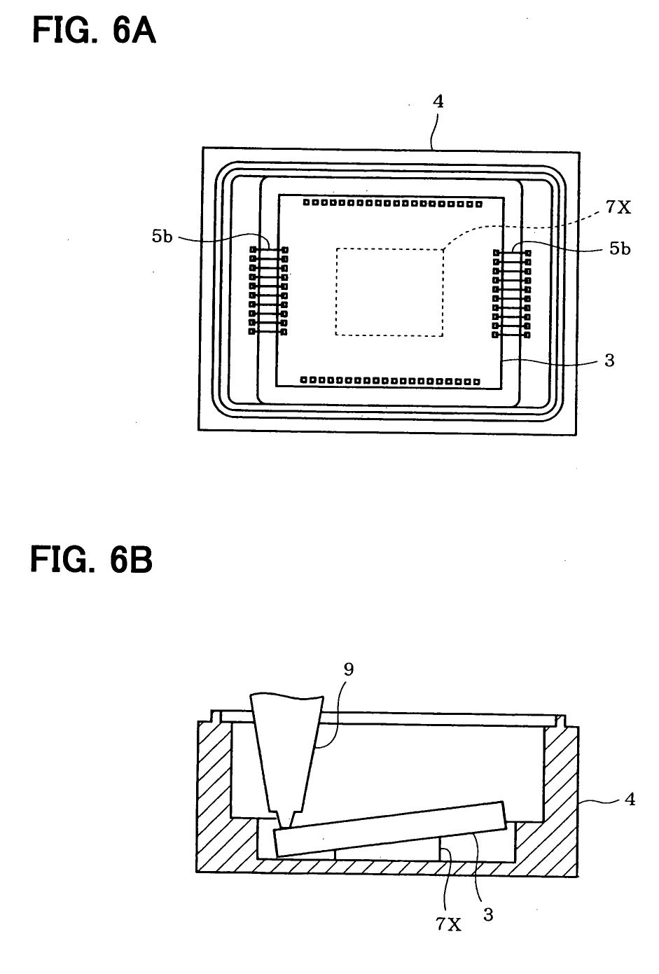

An adhesive film 7X according to a comparative example has a shape similar to the circuit chip 3 and is disposed on a center portion of the circuit chip 3, as shown in FIG. 6A. The shape of the adhesive film 7X satisfies the above-described two requirements.

As described above, the sensor chip 2 and the circuit chip 3 are coupled with the bonding wires 5a, and the circuit chip 3 and the casing 4 are coupled with the bonding wires 5b. When the circuit chip 3 disposed on the adhesive film 7X is wire bonded with the casing 4 by using a wire-bonding tool 9, the circuit chip 3 may incline, and thereby the wire-bonding tool 9 may slip. As a result, a bonding activity may be reduced.

In the present embodiment, the first adhesive film 7 has an area smaller than the bottom area of the sensor chip 2 and has a shape determined in such a manner that a distance between the first adhesive film 7 and an outer peripheral edge of the sensor chip 2 becomes a minimum at portions adjacent to the centerlines of the sensor chip 2. The second adhesive film 8 has an area smaller than the bottom area of the circuit chip 3 and has a shape determined in such a manner that a distance between the second adhesive film 8 and an outer peripheral edge of the circuit chip 3 becomes a minimum at portions adjacent to centerlines of the circuit chip 3.

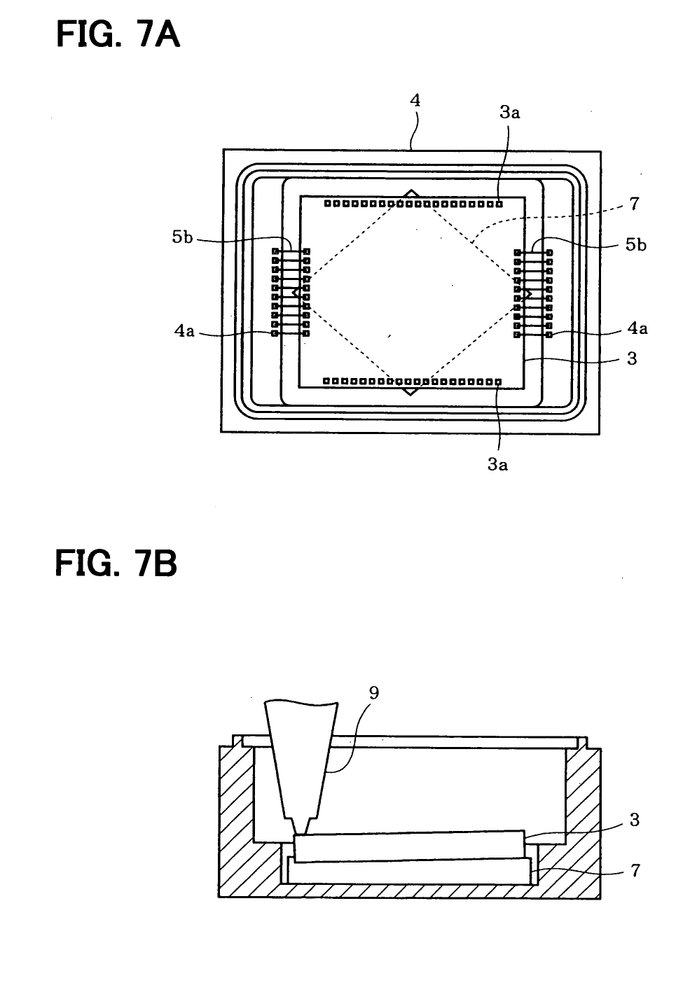

For example, the first adhesive film 7 and the second adhesive film 8 have approximately square shapes or approximately rhombus shapes. The first adhesive film 7 and the second adhesive film 8 are arranged in such a manner that corner portions of the first adhesive film 7 and the second adhesive film 8 are located outside of the bonding pads 2a and 3a of the sensor chip 2 and the circuit chip 3, respectively, as shown in FIG. 7A. In the present case, even if a pressure is applied to the circuit chip 3 and the sensor chip 2 at the wire-bonding process, the circuit chip 3 and the sensor chip 2 are difficult to incline, as shown in FIG. 7B. Thus, the wire-bonding tool 9 is difficult to slip and the bonding activity can be improved.

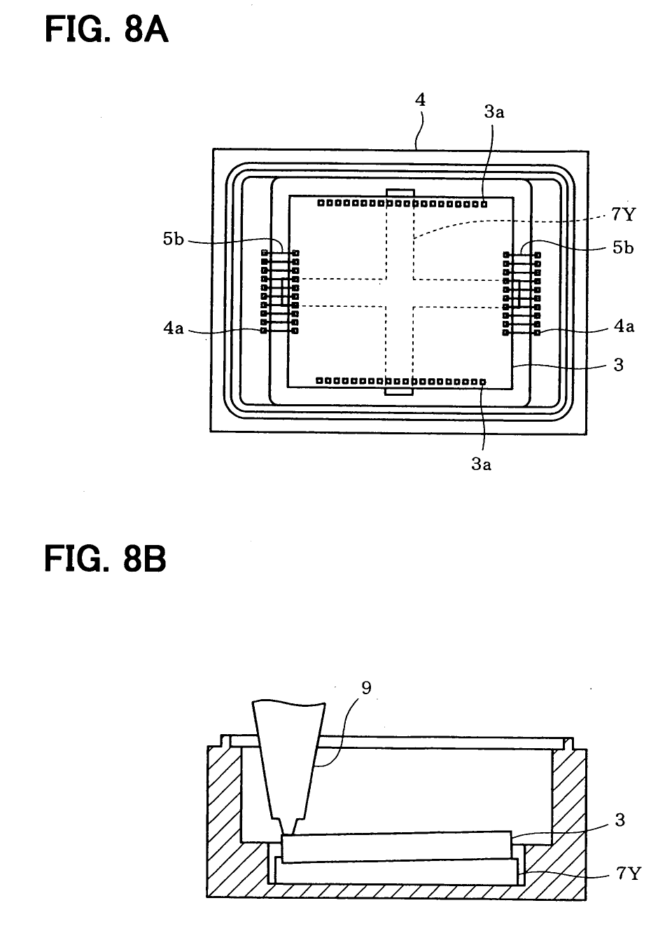

In FIGS. 7A and 7B, the first adhesive film 7 and the second adhesive film 8 have approximately rhombus shapes, as an example. Alternatively, an adhesive film 7Y having a cross shape may be used, for example. In the present case, each end portion of the adhesive film 7Y are located outside of the bonding pads 2a and 3a of the sensor chip 2 and the circuit chip 3, as shown in FIG. 8A. The adhesive film 7Y satisfies the above-described two requirements and can restrict the inclination at the wire bonding.

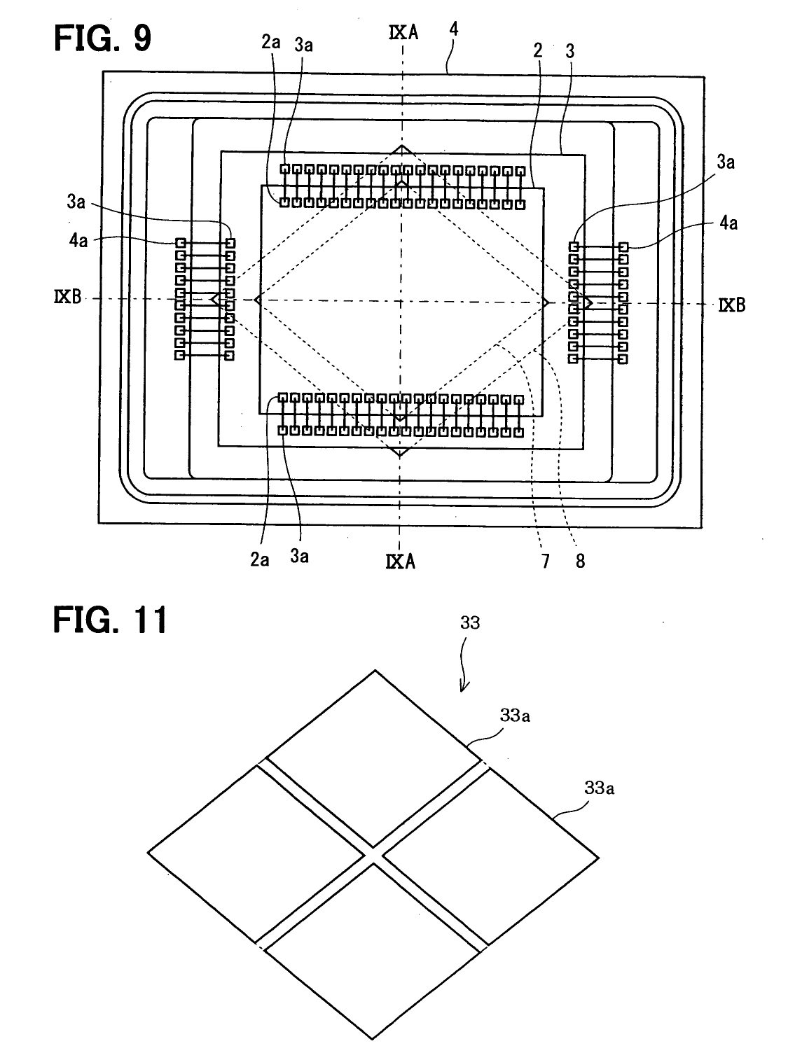

In the angular velocity sensor 1 shown in FIG. 9, diagonal lines of the first adhesive film 7 and the second adhesive film 8 are located on centerlines IXA-IXA and IXB-IXB of the sensor chip 2 and the circuit chip 3. The centerlines IXA-IXA and IXB-IXB correspond to the lines IIIA-IIIA and IIIB-IIIB of the sensor chip 2 shown in FIG. 3. When the sensor chip 2 and the circuit chip 3 have approximately square shapes, the first adhesive film 7 and the second adhesive film 8 have approximately square shapes. When the sensor chip 2 and the circuit chip 3 have approximately rectangular shapes, the first adhesive film 7 and the second adhesive film 8 have approximately rhombus shapes.

The first adhesive film 7 is similar to the second adhesive film 8 and is smaller than the second adhesive film 8. The first adhesive film 7 attaches the sensor chip 2 and the circuit chip 3. Four corner portions of the first adhesive film 7 protrude from middle portions of four sides of the sensor chip 2 to an outside of the sensor chip 2, respectively. The second adhesive film 8 attaches the circuit chip 3 and the casing 4. Four corner portions of the second adhesive film 8 protrude from middle portions of four sides of the circuit chip 3 to an outside of the circuit chip 3, respectively. In addition, the stiffening member 22a and the spindles 211a are provided between the opposing corner portions of the second adhesive film 8.

When a stress is transmitted to the sensor chip 2 from the second adhesive film 8, the sensor chip 2 deforms from an attached portion of the sensor chip 2 and the second adhesive film 8. In the present case, the amount of displacement is largest at a center point of the attached portion, that is, a center point of the sensor chip 2. However, the displacement is reduced by the stiffening member 22a disposed at the center portion of the sensor chip 2. Specifically, as shown in FIG. 3, a displacement in the Y-axis direction is restricted by Y-axial parts of the stiffening member 22a and a displacement in the X-axis direction is restricted by the X-axial parts 22a1 of the stiffening member 22a and the spindles 211a of the driving portions 211.

As shown in FIG. 9, the corner portions of the first adhesive film 7 and the second adhesive film 8 are located outside of the bonding pads 2a and 3a of the sensor chip 2 and the circuit chip 3, respectively. Thus, the sensor chip 2 and the circuit chip 3 are restricted from inclining at the wire-bonding process, and the wire-bonding tool 9 is restricted from slipping.

As described above, the angular velocity sensor 1 includes the sensor chip 2 and the circuit chip 3 each having the approximately quadrilateral shape. The first adhesive film 7 and the second adhesive film 8 have the approximately square shapes or the approximately rhombus shapes. The first adhesive film 7 and the second adhesive film 8 are arranged in such a manner that the diagonal lines of the first adhesive film 7 and the second adhesive film 8 are located on the centerlines of the sensor chip 2 and the circuit chip 3, respectively. Thus, the areas of the first adhesive film 7 and the second adhesive film 8 can be smaller than the areas of the bottom surfaces of the sensor chip 2 and the circuit chip 3, respectively. Furthermore, the distance between the first adhesive film 7 and an outer peripheral edge of the sensor chip 2 becomes the minimum at portions adjacent to the centerlines of the sensor chip 2, and the distance between the second adhesive film 8 and an outer peripheral edge of the circuit chip 3 becomes the minimum at portions adjacent to centerlines of the circuit chip 3. Thereby, the property fluctuation due to the external stress can be restricted while ensuring the sufficient adhesive force for attaching the sensor chip 2 and the circuit chip 3.

Because the first adhesive film 7 and the second adhesive film 8 are used as an adhesive agent, a process for applying the adhesive agent can be omitted. Thus, a manufacturing process can be simplified. Furthermore, the corner portions of the first adhesive film 7 and the second adhesive film 8 are located outside of the bonding pads 2a and 3a of the sensor chip 2 and the circuit chip 3, respectively. Thus, the wire-bonding tool 9 is restricted from slipping at the wire-bonding process.

The bonding pads 2a and 3a are arranged along each side of the sensor chip 2 and the circuit chip 3 centering on the middle portions. In addition, the corner portions of the first adhesive film 7 and the second adhesive film 8 protrude from the middle portions of each side of the sensor chip 2 and the circuit chip 3. Thus, the wire-bonding tool 9 is restricted from slipping and the property fluctuation due to the external stress can be reduced.

### Second Embodiment

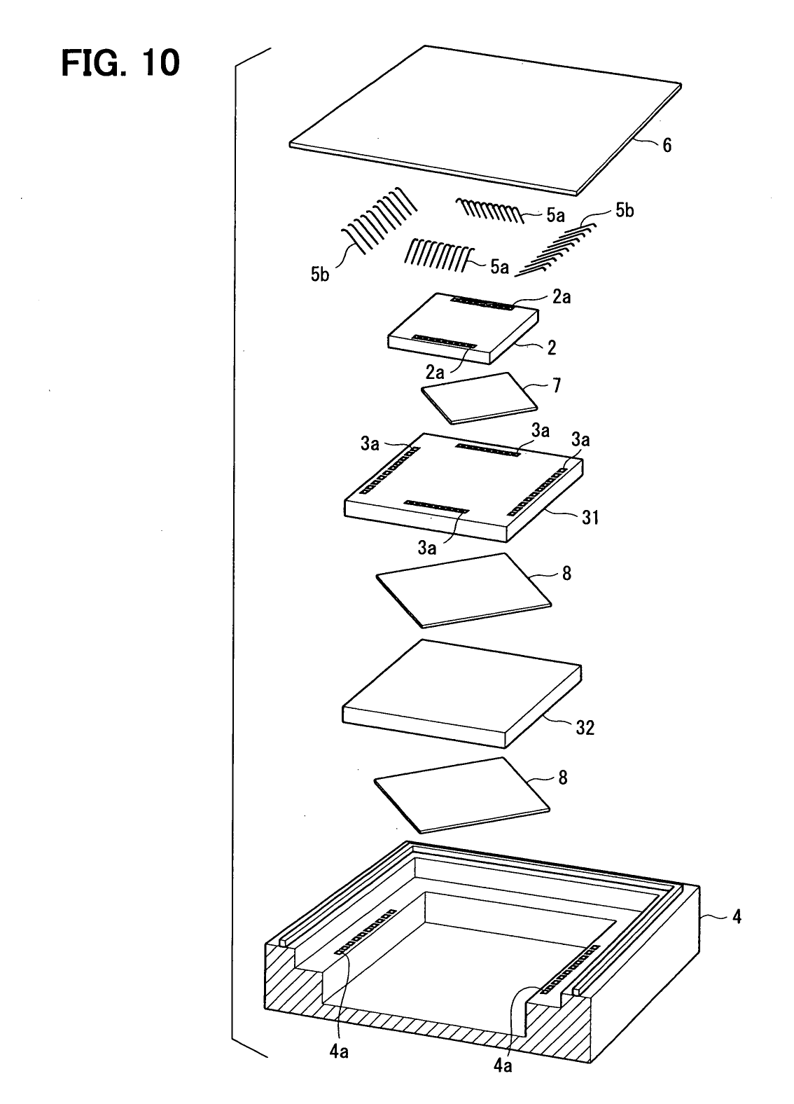

An angular velocity sensor according to a second embodiment of the invention includes the sensor chip 2, an analog circuit chip 31, and a digital circuit chip 32, as shown in FIG. 10. The analog circuit chip 31 is attached to the digital circuit chip 32 through the second adhesive film 8, and the digital circuit chip 32 is attached to the casing 4 through the second adhesive film 8. Even when the angular velocity sensor has a three-layer chip structure, the property fluctuation can be reduced similarly to a two-layer chip structure.

The number of circuit chip may be greater than or equal to three. When the number of the chip layer increases, an adhesive film located at the lower layer requires the more adhesion force and has the larger attached area. However, as shown in the experimental result shown in FIG. 5, even when the attached area ratio is 100%, the property fluctuation can be reduced by increasing the number of the adhesive film. In the present case, the circuit chips may be made of the same materials. In addition, the second adhesive films 8 disposed between the circuit chips may be made of another same materials. Alternatively, the second adhesive films 8 disposed between the circuit chips may have elasticity.

### Other Embodiments

Although the present invention has been fully described in connection with the preferred embodiments thereof with reference to the accompanying drawings, it is to be noted that various changes and modifications will become apparent to those skilled in the art.

For example, each of the first adhesive film 7 and the second adhesive film 8 may have a shape at which the cross shape shown in FIG. 8A is layered on the approximately square shape or the approximately rhombus shape. Alternatively, each of the first adhesive film 7 and the second adhesive film 8 may have plural pieces. For example, an adhesive film 33 that has an approximately rhombus shape configurated with a plurality of rhombus pieces 33a, as shown in FIG. 11, may be used.

The second adhesive film 8 may be thicker than the first adhesive film 7. Alternatively, a first area ratio of the first adhesive film 7 to the sensor chip 2 may be less than or equal to a second area ratio of the second adhesive film 8 to the circuit chip 3.

Instead of the first adhesive film 7 and the second adhesive film 8, an adhesive agent may be applied to the sensor chip 2 and the circuit chip 3. In the present case, the adhesive agent is applied to have a shape similar to the first adhesive film 7 and the second adhesive film 8, respectively.

The above-described embodiments may be applied to other sensor device for detecting physical quantity, for example, an acceleration sensor.

What is claimed is:

1. A sensor device comprising:
a sensor chip that is configured to detect a physical quantity applied thereto;
a circuit chip that is electrically coupled with the sensor chip and that is configured to process a signal from the sensor chip;
a casing that houses the sensor chip and the circuit chip;
a first adhesive member that is disposed between the sensor chip and the circuit chip, that has an area smaller than an area of the sensor chip, and that has a shape determined in such a manner that a distance between the first adhesive member and an outer peripheral edge of the sensor chip becomes a minimum at a portion adjacent to a centerline of the sensor chip; and
a second adhesive member that is disposed between the circuit chip and the casing, that has an area smaller than an area of the circuit chip, and that has a shape determined in such a manner that a distance between the second adhesive member and an outer peripheral edge of the circuit chip becomes a minimum at a portion adjacent to a centerline of the circuit chip.

2. The sensor device according to claim 1, wherein:
the sensor chip has an approximately quadrilateral shape and the centerline of the sensor chip connects middle points of opposing sides of the approximately quadrilateral shape; and
the circuit chip has an approximately quadrilateral shape and the centerline of the circuit chip connects middle points of opposing sides of the approximately quadrilateral shape.

3. The sensor device according to claim 1, wherein
the first adhesive member has a similar shape to the second adhesive member.

4. The sensor device according to claim 1, wherein:
the sensor chip has an approximately square shape;
the first adhesive member has an approximately square shape; and
the first adhesive member is arranged in such a manner that two diagonal lines of the first adhesive member are located on two centerlines of the sensor chip, respectively.

5. The sensor device according to claim 1, wherein:
the sensor chip has an approximately rectangular shape;
the first adhesive member has an approximately rhombus shape; and
the first adhesive member is arranged in such a manner that two diagonal lines of the first adhesive member are located on two centerlines of the sensor chip, respectively.

6. The sensor device according to claim 1, wherein:
the circuit chip has an approximately square shape;
the second adhesive member has an approximately square shape; and
the second adhesive member is arranged in such a manner that two diagonal lines of the second adhesive member are located on two centerlines of the circuit chip, respectively.

7. The sensor device according to claim 1, wherein:
the circuit chip has an approximately rectangular shape;
the second adhesive member has an approximately rhombus shape; and
the second adhesive member is arranged in such a manner that two diagonal lines of the second adhesive member are located on two centerlines of the circuit chip, respectively.

8. The sensor device according to claim 1, wherein:
each of the sensor chip and the circuit chip has a bonding pad;
an end portion of the first adhesive member is located outside of the bonding pad of the sensor chip; and
an end portion of the second adhesive member is located outside of the bonding pad of the circuit chip.

9. The sensor device according to claim 1, wherein
each of the first adhesive member and the second adhesive member is an adhesive film.

10. The sensor device according to claim 1, wherein
at least one of the first adhesive member and the second adhesive member includes a plurality adhesive films.

11. The sensor device according to claim 1, wherein:
the first adhesive member has a first thickness; and
the second adhesive member has a second thickness that is larger than the first thickness.

12. The sensor device according to claim 1, wherein
a first area ratio of the first adhesive member to the sensor chip is less than or equal to a second area ratio of the second adhesive member to the circuit chip.

13. The sensor device according to claim 1, wherein
the circuit chip includes a plurality of chip elements that is stacked through a third adhesive member having an elasticity.

14. The sensor device according to claim 13, wherein:
the circuit chip includes at least three chip elements that are made of same materials; and
the third adhesive members disposed between the chip elements are made of another same materials.

15. The sensor device according to claim 13, wherein
the third adhesive member includes a plurality of adhesive films.

16. A sensor device comprising:
a sensor chip that is configured to detect a physical quantity applied thereto, that has an approximately quadrilateral shape, and that has a plurality of bonding pad arranged along at least one side of the approximately quadrilateral shape;
a circuit chip that has an approximately quadrilateral shape and that has a plurality of bonding pads arranged along at least one side of the approximately quadrilateral shape, wherein a part of the bonding pads is electrically coupled with the plurality of the bonding pads of the sensor chip;
a casing that houses the sensor chip and the circuit chip and that has a plurality of bonding pads electrically coupled with the other part of the bonding pads of the circuit chip;
a first adhesive member that is disposed between the sensor chip and the circuit chip, that has an area smaller than an area of the sensor chip, and that has an end portion located outside of the plurality of bonding pads of the sensor chip; and
a second adhesive member that is disposed between the circuit chip and the casing, that has an area smaller than an area of the circuit chip, and that has an end portion located outside of the plurality of bonding pads of the circuit chip.

17. The sensor device according to claim 16, wherein
the first adhesive member has an quadrilateral shape and is arranged in such a manner that two diagonal lines of the first adhesive member are located on two centerlines of the sensor chip; and
the second adhesive member has an quadrilateral shape and is arranged in such a manner that two diagonal lines of the second adhesive member are located on two centerlines of the sensor chip.

18. The sensor device according to claim 17, wherein
four corner portions of the first adhesive member protrude from middle portions of four sides of the sensor chip to an outside of the sensor chip; and
four corner portions of the second adhesive member protrude from middle portions of four sides of the circuit chip to an outside of the circuit chip.

19. The sensor device according to claim 16, wherein
the first adhesive member has approximately cross shape that includes four end portions protruding from middle portions of four sides of the sensor chip to an outside of the sensor chip.

20. The sensor device according to claim 16, wherein
the second adhesive film has approximately cross shape that includes four end portions protruding from middle portions of four sides of the circuit chip to an outside of the circuit chip.
